(19) United States
(12) Patent Application Publication
(10) Pub. No.: US 2025/0166336 A1
(43) Pub. Date: May 22, 2025

(54) IMAGE PROCESSING APPARATUS, AUTHENTICATION SYSTEM, IMAGE PROCESSING METHOD, AND NON-TRANSITORY COMPUTER-READABLE MEDIUM

(71) Applicant: NEC Corporation, Minato-ku, Tokyo (JP)

(72) Inventors: Masayoshi YAMAURA, Tokyo (JP); Tomohiro HATAE, Tokyo (JP); Hisayoshi MURA, Tokyo (JP)

(73) Assignee: NEC Corporation, Minato-ku, Tokyo (JP)

(21) Appl. No.: 18/840,192

(22) PCT Filed: May 30, 2022
(86) PCT No.: PCT/JP2022/021906

§ 371 Date: Aug. 21, 2024

(51) Int. Cl. G06V 10/22; G06V 20/52; G06V 40/16

(52) U.S. Cl. CPC G06V 10/22; G06V 20/53; G06V 40/166

(57) ABSTRACT

The image processing apparatus (20) includes: a setting unit (22) configured to set a designated part other than a face of a target person as a target part; an authentication unit (24) configured to determine whether or not a predetermined target person is included in a captured image obtained by capturing an area within a predetermined range with respect to a gate; an area specification unit (25) configured to specify a first area that is a face area of the target person and a second area that is an image area of the target part as a specific area not to be subjected to abstraction processing in a case where the target person is included in the captured image; and an abstraction unit (26) configured to perform abstraction processing on an image area except for the specified specific area.

### TECHNICAL FIELD

The present disclosure relates to an image processing apparatus, an authentication system, an image processing method, and a non-transitory computer-readable medium.

### BACKGROUND ART

A technique for protecting the privacy of a passerby appearing in an image obtained by capturing a subject has been proposed. For example, Patent Literature 1 discloses an image processing apparatus that performs blur processing on a background area that is an area other than the main subject area of a target image.

### CITATION LIST

### Patent Literature

Patent Literature 1: Japanese Unexamined Patent Application Publication No. 2021-012597

### SUMMARY OF INVENTION

### Technical Problem

In recent years, demonstration experiments of face authentication have been actively carried out at airports and stations where ordinary passengers pass. In the demonstration experiments of face authentication, it is desirable to store the captured image for verification of results for a certain period. Therefore, there is a particularly increasing need to protect the privacy of the passerby captured in the image.

In such a face authentication system, it is required to flexibly set a hidden area and an unhidden area according to a verified target or depending on the operation. However, in the technique described in Patent Literature 1 described above, it is difficult to flexibly set an area to be subjected to blur processing.

In view of the above-described problems, an object of the present disclosure is to provide an image processing apparatus, an authentication system, an image processing method, and a non-transitory computer-readable medium capable of flexibly setting a hidden area or an unhidden area for the captured image.

### Solution to Problem

An image processing apparatus according to an aspect of the present disclosure includes: a setting means for setting a designated part other than a face of a target person as a target part: an authentication means for determining whether or not a predetermined target person is included in a captured image obtained by capturing an area within a predetermined range with respect to a gate; an area specification means for specifying a first area that is a face area of the target person and a second area that is an image area of the target part as a specific area not to be subjected to abstraction processing in a case where the target person is included in the captured image; and an abstraction means for performing abstraction processing on an image area except for the specified specific area.

An authentication system according to an aspect of the present disclosure includes an authentication apparatus that performs face authentication based on a face area of a target person, and an image processing apparatus. The image processing apparatus includes: a setting means for setting a designated part other than a face of a target person as a target part: an authentication means for determining whether or not a predetermined target person is included in a captured image obtained by capturing an area within a predetermined range with respect to a gate: an area specification means for specifying a first area that is a face area of the target person and a second area that is an image area of the target part as a specific area not to be subjected to abstraction processing in a case where the target person is included in the captured image; and an abstraction means for performing abstraction processing on an image area except for the specified specific area.

An image processing method according to an aspect of the present disclosure includes: setting a designated part other than a face of a target person as a target part: determining whether or not a predetermined target person is included in a captured image obtained by capturing an area within a predetermined range with respect to a gate: specifying a first area that is a face area of the target person and a second area that is an image area of the target part as a specific area not to be subjected to abstraction processing in a case where the target person is included in the captured image; and performing abstraction processing on an image area except for the specified specific area.

A non-transitory computer-readable medium according to an aspect of the present disclosure stores a program for causing a computer to implement: a function of setting a designated part other than a face of a target person as a target part: a function of determining whether or not a predetermined target person is included in a captured image obtained by capturing an area within a predetermined range with respect to a gate: a function of specifying a first area that is a face area of the target person and a second area that is an image area of the target part as a specific area not to be subjected to abstraction processing in a case where the target person is included in the captured image; and a function of performing abstraction processing on an image area except for the specified specific area.

### Advantageous Effects of Invention

According to the present disclosure, it is possible to provide an image processing apparatus, an authentication system, an image processing method, and a non-transitory computer-readable medium capable of flexibly setting a hidden area or an unhidden area for the captured image.

### BRIEF DESCRIPTION OF DRAWINGS

FIG. 1 is a block diagram illustrating a configuration of an image processing apparatus according to a first example embodiment.

FIG. 2 is a flowchart illustrating an example of a flow of image processing according to the first example embodiment.

FIG. 3 is a block diagram illustrating an overall configuration of an authentication system according to a second example embodiment.

FIG. 4 is a block diagram illustrating a configuration of an authentication terminal according to the second example embodiment.

FIG. 5 is a block diagram illustrating a configuration of an authentication apparatus according to the second example embodiment.

FIG. 6 is a flowchart illustrating an example of a flow of face information registration processing according to the second example embodiment.

FIG. 7 is a flowchart illustrating an example of a flow of authentication processing according to the second example embodiment.

FIG. 8 is a view for describing a specific example of authentication processing according to the second example embodiment.

FIG. 9 is a block diagram illustrating a configuration of an image processing apparatus according to the second example embodiment.

FIG. 10 is a flowchart illustrating an example of a flow of image processing according to the second example embodiment.

FIG. 11 is a view for describing an example of the display of a display unit 250 according to the second example embodiment.

FIG. 12 is a view for describing a specific example of image processing according to the second example embodiment.

FIG. 13 is a view for describing the specific example of image processing according to the second example embodiment.

FIG. 14 is a view for describing the specific example of image processing according to the second example embodiment.

### EXAMPLE EMBODIMENT

Hereinafter, example embodiments of the present disclosure will be described in detail with reference to the drawings. In the drawings, the same or corresponding elements are denoted by the same reference numerals, and repeated descriptions will be omitted as necessary for clarity of description.

### First Example Embodiment

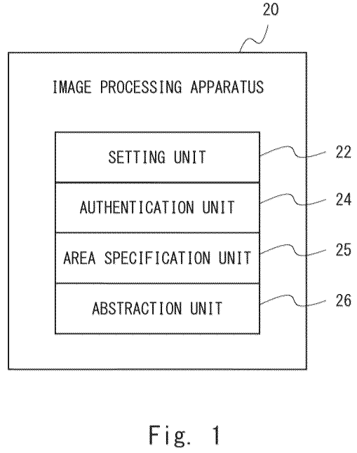

Next, the first example embodiment of the present disclosure will be described. FIG. 1 is a block diagram illustrating a configuration of an image processing apparatus 20 according to the first example embodiment. The image processing apparatus 20 is one or a plurality of apparatuses that perform abstraction processing on an image area other than a specific area in a captured image.

The specific area is an area not to be subjected to abstraction processing. The abstraction processing is a process of processing so that an object or a person appearing in an image area to be subjected to the abstraction processing cannot be identified. The abstraction processing is, for example, mosaic processing, blur processing, fill processing, or transparency processing. In the first example embodiment, the specific area is an area obtained by combining a first area included in the captured image and a second area included in the captured image.

A first area is a predetermined face area of the target person. For example, the target person is a performer or cooperator of a demonstration experiment of face authentication. The second area is an image area of a pre-designated target part by a user of the image processing apparatus 20. The target part may be at least one of a body part of the target person except for the face, baggage possessed by the target person, and decorative articles worn by the target person. In addition, in the experiment for authenticating the face of the target person passing the gate, the target part may be a reading unit such as an IC card reader installed at the gate.

The image processing apparatus 20 includes a setting unit 22, an authentication unit 24, an area specification unit 25, and an abstraction unit 26.

The setting unit 22 is also referred to as a setting means. The setting unit 22 sets a designated part as the target part. For example, the setting unit 22 receives a designation of the type of the target part from the user of the image processing apparatus 20 and sets the target part. In addition, for example, the setting unit 22 sets the target part based on the information for designating the type of the target part, in response to receiving information for designating the type of the target part from another apparatus.

The authentication unit 24 is also referred to as an authentication means. The authentication unit 24 determines whether or not a predetermined target person is included in a captured image obtained by capturing an area within a predetermined range with respect to the gate.

For example, the authentication unit 24 may determine whether or not the target person is included in the captured image by controlling face authentication for the face area of each person included in the captured image. Controlling the face authentication may mean that the image processing apparatus 20 performs face authentication. Alternatively, controlling the face authentication may mean that the image processing apparatus 20 requests another face authentication apparatus (not illustrated) to perform face authentication and receives the results of face authentication from the face authentication apparatus. Then, the authentication unit 24 may determine whether the target person is included in the detected person based on the results of face authentication.

The area specification unit 25 is also referred to as an area specification means. In a case where the target person is included in the captured image, the area specification unit 25 specifies the first area and the second area as the specific area. The specific area is an image area not to be subjected to abstraction processing.

The abstraction unit 26 is also referred to as an abstraction means. The abstraction unit 26 performs abstraction processing on an image area except for the specific area by converting pixel values of pixels included in the image area except for the specific area in the captured image. On the other hand, the abstraction unit 26 does not convert the pixel values for the specific area. That is, the abstraction unit 26 does not perform the abstraction processing on the specific area.

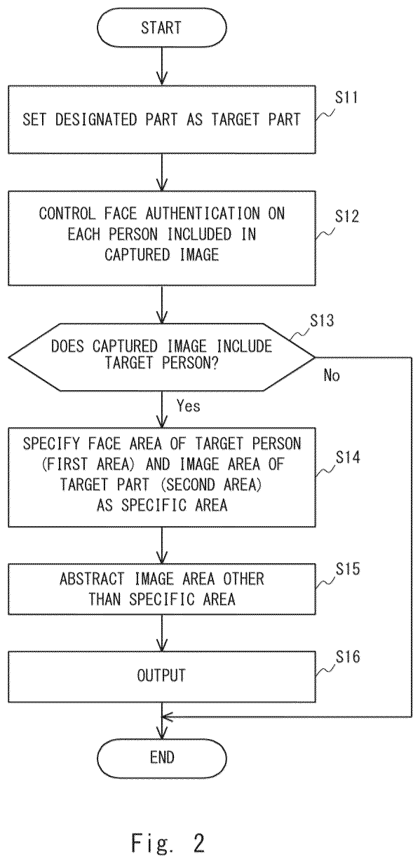

FIG. 2 is a flowchart illustrating an example of a flow of image processing according to the first example embodiment. First, the setting unit 22 of the image processing apparatus 20 sets a designated part as a target part (S11). For example, the setting unit 22 receives the designation of a type of the target part from a user of the image processing apparatus 20 and sets a received part as the target part. At this time, the user may designate a hand, a finger, an ear, or a posture of the target person as the type of the target part. In addition, the user may designate baggage possessed by the target person or decorative articles worn by the target person as the type of the target part. In addition, the user may designate the reading unit installed at the gate as the type of the target part.

Next, the authentication unit 24 controls face authentication on each person included in the captured image (S12). Accordingly, the authentication unit 24 acquires the results of face authentication. Then, the authentication unit 24 determines whether the captured image includes the target person (S13).

In a case where the authentication unit 24 determines that the captured image includes the target person (Yes in S13), the area specification unit 25 specifies the face area of the target person (that is, the first area) and the image area of the target part (that is, the second area) as a specific area (S14). Next, the abstraction unit 26 performs abstraction processing on an image area other than the specific area in the captured image (S15). Then, the image processing apparatus 20 outputs the abstracted image (S16).

On the other hand, in a case where the authentication unit 24 determines that the target person is not included in the captured image (No in S13), the image processing apparatus 20 ends the processing.

Furthermore, in S16, the image processing apparatus 20 may store the abstracted image in a storage device.

According to the first example embodiment as described above, the face area of the target person and the target part designated by the user of the image processing apparatus 20 are set as unhidden areas, and the abstraction processing is performed on other image areas. Therefore, it is possible to flexibly set a hidden area or an unhidden area according to the verified target or depending on the operation.

### Second Example Embodiment

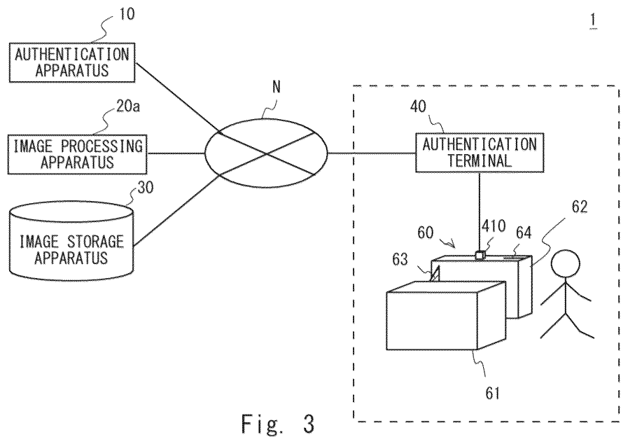

Next, the second example embodiment of the present disclosure will be described. FIG. 3 is a block diagram illustrating an overall configuration of an authentication system 1 according to the second example embodiment. The authentication system 1 is a computer system that performs a demonstration experiment for performing personal authentication on a person passing a gate 60. The authentication system 1 stores the captured image used for the personal authentication for a predetermined period. In the second example embodiment, the personal authentication is face authentication.

The authentication system 1 includes an authentication apparatus 10, an image processing apparatus 20a, an image storage apparatus 30, an authentication terminal 40, and a gate 60. The authentication apparatus 10, the image processing apparatus 20a, the image storage apparatus 30, and the authentication terminal 40 are communicably connected through the network N.

The network N is a wired or wireless communication network.

The gate 60 may be a ticket gate of a station where the demonstration experiment is performed, a gate of an airport, a gate of a concert hall or an amusement park, or the like. The gate 60 includes a first gate body 61 and a second gate body 62.

The first gate body 61 and the second gate body 62 are separated from each other at a predetermined interval in a direction orthogonal to the traveling direction of a passerby. A camera 410 of the authentication terminal 40 is disposed in the gate 60, the camera 410 captures an image of the passerby, and the authentication apparatus 10 performs face authentication based on the captured image. Then, the gate 60 is opened or closed based on the results of the face authentication.

Opening or closing the gate 60 means rotating or sliding a flap 63 into the open or closed state. However, opening or closing the gate 60 may mean unlocking or locking the flap 63, or simply displaying or outputting by voice whether or not to permit passage. Furthermore, the flap 63 is not essential in the gate 60.

Furthermore, although the camera 410 is illustrated to be disposed on the second gate body 62 in the present drawing, the present invention is not limited thereto, and the camera may be disposed on the first gate body 61. In addition, the camera 410 may be provided to be separated from the gate 60.

The authentication apparatus 10 is an example of a face authentication apparatus that performs face authentication based on a face area of a person. The authentication apparatus 10 stores face information for each target person, and performs face authentication on a person passing the gate 60 by using the stored face information.

For example, in response to receiving the captured image from the authentication terminal 40, the authentication apparatus 10 detects the face area of the person from the captured image and performs face authentication on the face area. The authentication apparatus 10 transmits the results of the face authentication to the authentication terminal 40.

The image processing apparatus 20a is an example of the image processing apparatus 20 of the first example embodiment. The image processing apparatus 20a performs abstraction processing on an image area other than the specific area in the captured image used for the face authentication by the authentication apparatus 10 and generates an image in which at least a part is abstracted. Hereinafter, an image in which at least a part is abstracted is referred to as an abstracted image. In the second example embodiment, the abstracted image is used to verify the results of the face authentication. The specific area that is an area not to be abstracted includes a face area of the target person and an image area of the target part. The target part is an area that is confirmed by a verifier at the time of verification in order to identify a situation at the time of face authentication. In the second example embodiment, the target part may be at least one of the body part of the target person except for the face, baggage possessed by the target person, and decorative articles worn by the target person.

Then, the image processing apparatus 20a stores a generated and abstracted image in the image storage apparatus 30.

The image storage apparatus 30 is a storage apparatus that stores the abstracted image generated by the image processing apparatus 20a. The abstracted image stored in the image storage apparatus 30 is deleted when a predetermined period has elapsed since the storage.

The authentication terminal 40 is a terminal apparatus including a camera 410 installed near the gate 60. The authentication terminal 40 transmits the captured image of the passerby captured by the camera 410 to the authentication apparatus 10 and requests the authentication apparatus 10 to perform face authentication. The authentication terminal 40 controls the opening and closing of the gate 60 based on the results of face authentication from the authentication apparatus 10.

Furthermore, the gate 60 and the authentication terminal 40 may be configured as separate apparatus or may be integrally configured. In addition, the gate 60 may not have an opening/closing mechanism. For example, the gate 60 may be a pole type instead of a configuration in which the main body is separated into two parts or may be simply a passage. In this case, the authentication terminal 40 may output whether or not to permit passage, instead of controlling the opening and closing of the gate 60.

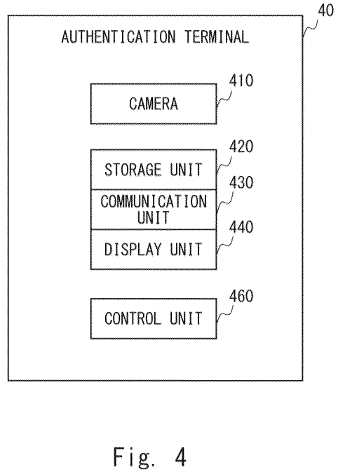

FIG. 4 is a block diagram illustrating a configuration of the authentication terminal 40 according to the second example embodiment. The authentication terminal 40 includes a camera 410, a storage unit 420, a communication unit 430, a display unit 440, and a control unit 460.

The camera 410 is an imaging apparatus that performs imaging under the control of the control unit 460. The storage unit 420 is a storage device that stores a program for implementing each function of the authentication terminal 40. The communication unit 430 is a communication interface with the network N. The display unit 440 is a display device. The control unit 460 controls hardware included in the authentication terminal 40.

For example, the control unit 460 controls the camera 410 to capture an image of an area within a predetermined range with respect to the gate, and transmits the captured image to the authentication apparatus 10 through the communication unit 430. In addition, the control unit 460 controls the opening and closing of the gate 60 based on the results of face authentication in response to the communication unit 430 receiving the results of face authentication from the authentication apparatus 10.

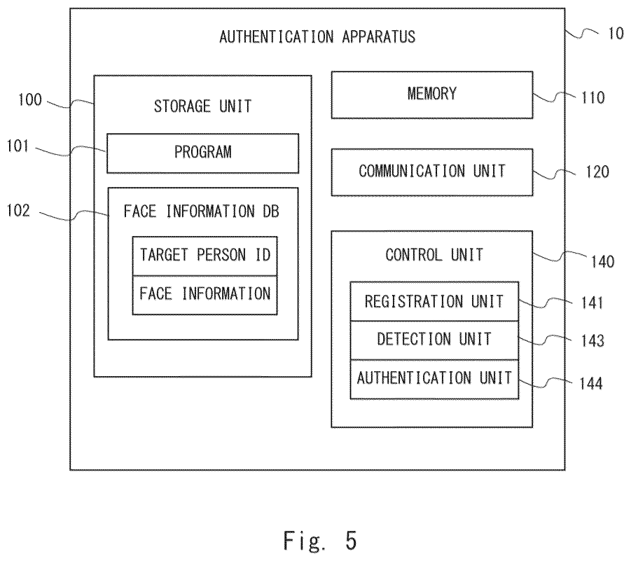

FIG. 5 is a block diagram illustrating a configuration of the authentication apparatus 10 according to the second example embodiment. The authentication apparatus 10 includes a storage unit 100, a memory 110, a communication unit 120, and a control unit 140.

The storage unit 100 is a storage device such as a hard disk or a flash memory. The storage unit 100 stores a program 101 and a face information DB 102. The program 101 is a computer program in which the processing by the authentication apparatus 10 is implemented.

The face information DB 102 stores a target person ID for identifying a target person and the face information of the target person in association with each other. The face information is a set of feature points extracted from the face image.

The memory 110 is a volatile storage device such as a random access memory (RAM) and is a storage area for temporarily holding information during the operation of the control unit 140. The communication unit 120 is a communication interface with the network N.

The control unit 140 is a processor that controls each component of the authentication apparatus 10, that is, a control apparatus. The control unit 140 reads the program 101 from the storage unit 100 into the memory 110 and executes the program 101. Accordingly, the control unit 140 implements the functions of the registration unit 141, the detection unit 143, and the authentication unit 144.

The registration unit 141 newly issues the target person ID when registering the face information. In addition, the registration unit 141 detects a face area from a registered image for registering face information, extracts feature points from the face area, and generates the information of the extracted feature points as face information. The registration unit 141 registers the issued target person ID and the face information for use of registration extracted from the registered image, in the face information DB 102 in association with each other.

The detection unit 143 detects the face area of the person from the captured image for use of authentication received from the authentication terminal 40 and supplies the face area to the authentication unit 144. In a case where the captured image includes a plurality of persons, the detection unit 143 detects the face area for each person, and supplies the face area to the authentication unit 144.

The authentication unit 144 extracts feature points from the face area detected by the detection unit 143 and sets the feature points as the face information for use of authentication. The authentication unit 144 performs face authentication by using the face information. Specifically, the authentication unit 144 collates the face formation extracted from the captured image for use of authentication, with the face information within the face information DB 102. Accordingly, the authentication unit 144 specifies the target person ID in which the pieces of face information match. Furthermore, a case where the pieces of face information match (presence of matching) means a case where a matching degree is equal to or more than a predetermined value.

The authentication unit 144 transmits the results of the face authentication to the authentication terminal 40 through the communication unit 120. In addition, the authentication unit 144 transmits the captured image for use of authentication to the image processing apparatus 20a through the communication unit 120.

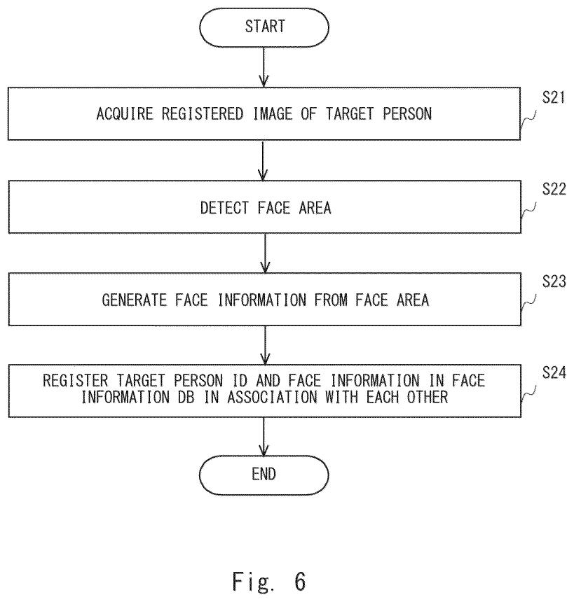

FIG. 6 is a flowchart illustrating an example of a flow of face information registration processing according to the second example embodiment. First, the registration unit 141 of the authentication apparatus 10 acquires a registered image of the target person (S21). For example, the authentication apparatus 10 acquires the registered image by receiving a face registration request including the registered image of the target person from a terminal used by the target person. Next, the registration unit 141 detects a face area included in the registered image (S22). Next, the registration unit 141 extracts face information from the face area detected in step S22 (S23). Finally, the registration unit 141 issues the target person ID, and registers the target person ID and the face information, in the face information DB 102 in association with each other (S24). Furthermore, the registration unit 141 may receive the face information from a face registration request source, instead of the registered image, and register the face information and the target person ID in the face information DB 102 in association with each other. In this case, the processing of S21 to S23 may be omitted.

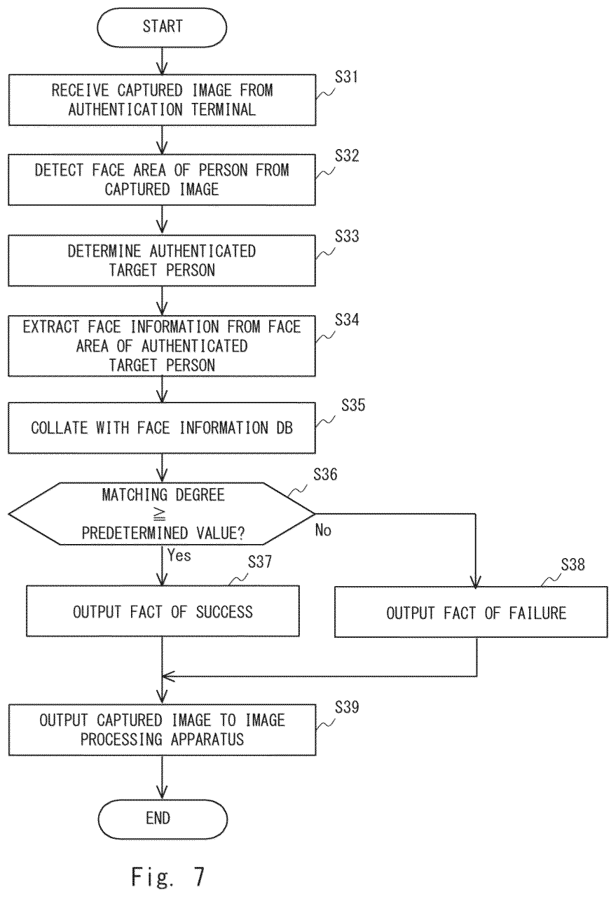

FIG. 7 is a flowchart illustrating an example of a flow of authentication processing according to the second example embodiment.

First, in response to receiving the captured image from the authentication terminal 40 (S31), the detection unit 143 detects a face area of a person from the captured image (S32). Here, in a case where face areas of a plurality of persons are detected, the detection unit 143 determines an authenticated target person from the plurality of persons (S33).

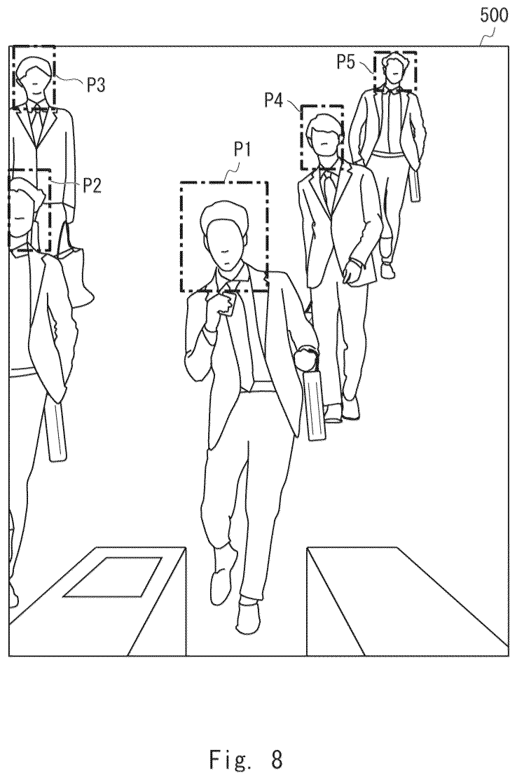

FIG. 8 is a view for describing the specific example of authentication processing according to the second example embodiment. FIG. 8 illustrates a captured image 500 obtained by capturing the vicinity of gate 60. The captured image 500 includes persons PI to P5 who are about to pass the gate 60. In S32, the detection unit 143 detects face areas of a plurality of persons PI to P5. Then, in S33, the detection unit 143 may determine the person PI closest to the gate 60 as the authenticated target person. In addition, in S33, the detection unit 143 may determine a person positioned within a predetermined range with respect to the gate 60 as the authenticated target person. The authentication unit 144 performs face authentication on the authenticated target person determined as described above.

Returning to FIG. 7, the description will be continued. The authentication unit 144 executes the processing illustrated in S34 to S38. First, the authentication unit 144 extracts face information from the face area of the authenticated target person (S34). Next, the authentication unit 144 collates the extracted face information with the face information in the face information DB 102 (S35). In a case where the matching degree of pieces of face information is equal to or more than a predetermined value (Yes in S36), the authentication unit 144 outputs the fact that the face authentication has succeeded, to the authentication terminal 40 (S37). On the other hand, in a case where the matching degree of pieces of face information is less than the predetermined value (No in S36), the authentication unit 144 outputs the fact that the face authentication has failed, to the authentication terminal 40 (S38).

Then, the authentication unit 144 outputs the captured image to the image processing apparatus 20a (S39).

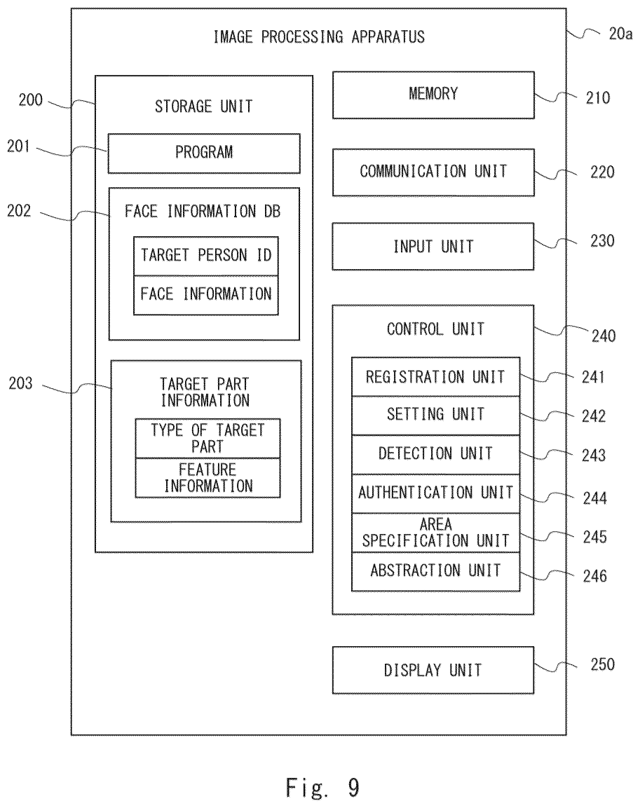

FIG. 9 is a block diagram illustrating a configuration of an image processing apparatus 20a according to the second example embodiment. The image processing apparatus 20a includes a storage unit 200, a memory 210, a communication unit 220, an input unit 230, a control unit 240, and a display unit 250.

The storage unit 200 is a storage apparatus such as a hard disk or a flash memory. The storage unit 200 stores a program 201, a face information DB 202, and target part information 203. The program 201 is a computer program in which the processing by the image processing apparatus 20a is implemented.

Similarly to the face information DB 102, the face information DB 202 stores the target person ID and the face information of the target person in association with each other.

The target part information 203 stores information regarding the target part. For example, the target part information 203 stores the type of the target part and the feature information of the target part in association with each other. For example, in a case where the type of the target part is “bag”, the feature information is information for detecting an image area of the bag of the target person. For example, the feature information may include information of a feature amount extracted from an image of a general bag. Alternatively, for example, the feature information may include a general relative position of the bag with respect to the face area. Furthermore, the relative position may be a value normalized by the size of the face area.

The memory 210 is a volatile storage device such as a random access memory (RAM), and is a storage area for temporarily holding information during the operation of the control unit 240. The communication unit 220 is a communication interface with the network N. The input unit 230 is an input apparatus that receives an input from the user of the image processing apparatus 20a.

The control unit 240 is a processor that controls each component of the image processing apparatus 20a, that is, a control apparatus. The control unit 240 reads the program 201 from the storage unit 200 into the memory 210 and executes the program 201. Accordingly, the control unit 240 implements the functions of the registration unit 241, the setting unit 242, the detection unit 243, the authentication unit 244, the area specification unit 245, and the abstraction unit 246.

The registration unit 241 is also referred to as a registration unit. The registration unit 241 has a similar function similar to the registration unit 141. That is, the registration unit 241 registers the target person ID and the face information for use of registration in the face information DB 202 in association with each other. The registration unit 241 may extract face information for use of registration from the registered image, or may receive, from the registration unit 141, the face information extracted from the registered image together with the target person ID. In the former case, the registration unit 241 executes processing similar to the processing illustrated in FIG. 6.

The setting unit 242 is an example of the setting unit 22 of the first example embodiment. The setting unit 242 receives the designation of the type of the target part from the user of the image processing apparatus 20a through the input unit 230. Then, the setting unit 242 sets a designated part as the target part.

The detection unit 243 is also referred to as a detection means. The detection unit 243 detects a face area of a person from the captured image for use of authentication received from the authentication apparatus 10 and supplies the face area to the authentication unit 244. A method of detecting the face area is similar to that of the detection unit 143. The face area detected by the detection unit 243 is also referred to as a first area. In a case where the captured image includes a plurality of persons, the detection unit 243 detects the face area for each person, and supplies the face area to the authentication unit 244.

The authentication unit 244 extracts feature points from the face area detected by the detection unit 243 and sets the feature points as the face information for use of authentication. The authentication unit 244 performs face authentication by using the face information. The face authentication method is similar to that of the authentication unit 144. Here, the person whose face authentication has succeeded is any one of the target persons registered in advance.

The authentication unit 244 supplies information of the face area (the first area) of the target person whose face authentication has succeeded, to an area specification unit 245.

The area specification unit 245 is an example of the area specification unit 25 of the first example embodiment. First, the area specification unit 245 detects a second area. Specifically, the area specification unit 245 detects the second area, which is the image area of the target part, based on the position of the face area of the target person specified by the authentication unit 244 and the type of the designated target part. More specifically, the area specification unit 245 detects the second area, by using the position of the face area of the target person and the feature information associated with the type of the target part in the target part information 203.

Then, the area specification unit 245 specifies the first area specified by the authentication unit 244 and the second area detected by itself as the specific area.

The abstraction unit 246 is an example of the abstraction unit 26 of the first example embodiment. The abstraction unit 246 performs converting pixel values for an image area other than the specific area in the captured image. Accordingly, the abstraction unit 246 performs abstraction processing on an image area other than the specific area.

The display unit 250 is a display device. For example, the display unit 250 displays an input screen for receiving the designation of the type of the target part from the user.

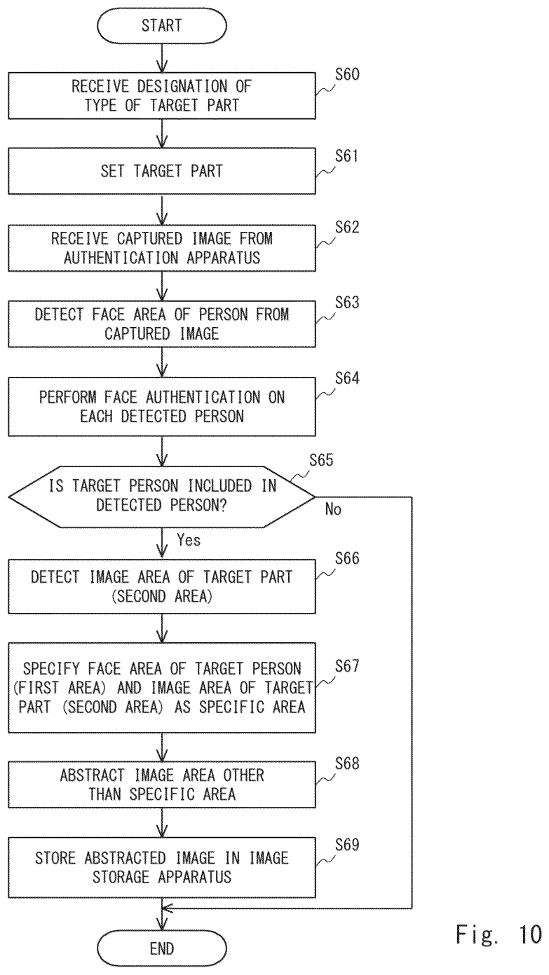

FIG. 10 is a flowchart illustrating an example of a flow of an image processing according to the second example embodiment. First, the setting unit 242 of the image processing apparatus 20a receives the designation of the type of the target part from the user (S60) and sets a designated part as the target part (S61).

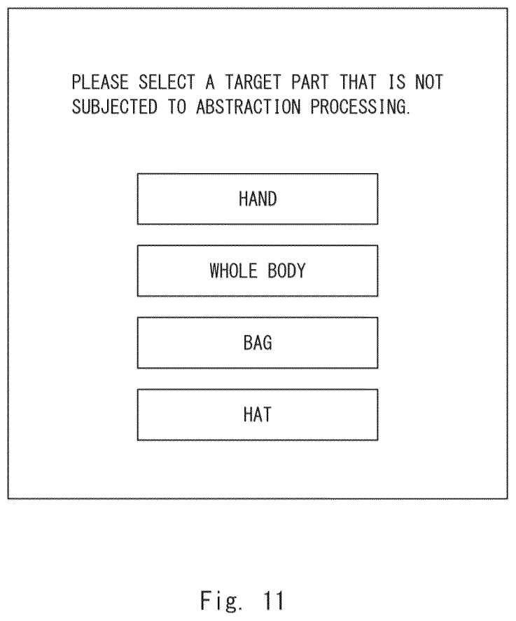

At this time, the display unit 250 may display an input screen 600 illustrated in FIG. 11. FIG. 11 is a view for describing an example of the display of a display unit 250 according to the second example embodiment. For example, the input screen 600 includes a message for prompting the selection of a target part not to be subjected to abstraction processing and further includes a selection area for the user to select one type from a plurality of types of target parts. The types of target parts given as options are, for example, a hand, a whole body, a bag, and a hat. The setting unit 242 accepts the designation of the type of the target part in response to the user selecting one type. Then, the setting unit 242 sets the target part according to the accepted designation.

Returning to FIG. 10, the description will be continued. Next, the communication unit 220 receives, from the authentication apparatus 10, the captured image used for the face authentication (S62). Next, the detection unit 243 detects a face area of a person from the captured image (S63). Next, the authentication unit 244 performs face authentication on each detected person (S64). Specifically, as illustrated in S34 to S36 of FIG. 7, the authentication unit 244 extracts the face information from the face area, collates the extracted face information with the face information in the face information DB 202, and determines whether the matching degree of pieces of face information is equal to or more than a predetermined value. In a case where the matching degree of the pieces of face information is equal to or more than a predetermined value, the authentication unit 244 determines that the face authentication has succeeded and determines that the person whose face authentication has succeeded is the target person registered in advance. On the other hand, in a case where the matching degree of pieces of face information is less than the predetermined value, the authentication unit 144 determines that the face authentication has failed.

The area specification unit 245 determines whether or not the target person is included in the detected person from the results of face authentication of all the detected persons (S65). In a case where the target person is not included in the detected person (No in S65), the image processing apparatus 20a ends the processing.

On the other hand, in a case where the target person is included in the detected person (Yes in S65), the area specification unit 245 detects the image area of the target part as the second area (S66). Specifically, the area specification unit 245 detects the second area by using the feature information associated with the type of the designated target part in the target part information 203.

Furthermore, the area specification unit 245 specifies, as the first area, the face area of the person determined to be the target person. Then, the area specification unit 245 specifies, as a specific area, the first area that is the face area of the target person and the second area that is the image area of the target part (S67).

Next, the abstraction unit 246 performs abstraction processing on an image area other than the specific area included in the captured image (S68).

Then, the abstraction unit 246 stores the abstracted image in the image storage apparatus 30 (S69).

Furthermore, although the target part is set in S61 in the above description, the target part may be set at any timing from S62 to S66. In this case, setting the target part may mean setting the image area (that is, the second area) of the target part, instead of setting the type of the target part. In the latter case, the processing illustrated in S66 may be omitted.

For example, the display unit 250 of the image processing apparatus 20a may display the captured image, and the setting unit 242 may set, as the second area, a portion designated by the user with respect to the captured image. As a method of designating the second area, the user may directly input the coordinates of the second area by using a keyboard, or may surround the second area by using a pointing device.

Furthermore, the setting unit 242 may receive the designation of the second area every time the captured image is received from the authentication apparatus 10, but the present invention is not limited thereto. For example, before starting the operation, the setting unit 242 may receive the designation of the second area from the user by using one or a plurality of captured images and cause the user to learn a second area detection model in which the second area is detected from the captured images. Then, after starting the operation, the setting unit 242 may detect the second area by using the learned second area detection model. Accordingly, the burden of designation by the user may be reduced.

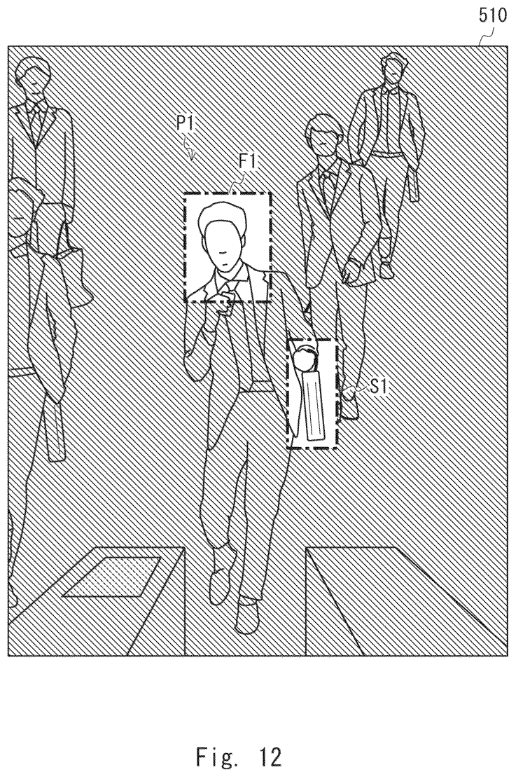

FIG. 12 is a view for describing a specific example of image processing according to the second example embodiment. The abstracted image 510 includes face areas of a plurality of persons detected by detection unit 243. The authentication unit 244 specifies, as a first area F1, a face area of the person PI in which the matching degree of the pieces of the face information of the target person registered in advance is equal to or more than a predetermined value. Then, the area specification unit 245 detects the image area of the target part by using the feature information associated with the type of the designated target part in the target part information 203 and specifies the image area as a second area S1.

For example, in a case where the feature information stored in the target part information 203 includes the information of the feature amount of the bag, the area specification unit 245 may detect, as a second area S1, an image area in which the matching degree of the feature amount is equal to or more than a predetermined threshold.

Alternatively, in a case where the feature information includes the relative position of the bag with respect to the face area, the area specification unit 245 may detect the second area S1 based on the position and size of the face area (the first area F1) of the target person and the relative position.

Alternatively, in a case where the feature information includes a relative position with respect to another part of the body, the area specification unit 245 may specify the second area S1 by using the relative position and the skeleton information. As an example, a bag is often positioned near a hand. Therefore, the area specification unit 245 may first extract the skeleton information of the target person and specify the position of the hand of the target person from the skeleton information. Then, the area specification unit 245 may detect an image area within a predetermined range from the specified position of the hand as the second area S1.

The area specification unit 245 may detect the second area S1 by combining some or all of the method using the feature amount of the bag, the method using the relative position with respect to the face area, and the method using the relative position with respect to another part of the body described above.

Then, the abstraction unit 246 performs abstraction processing on an image area except for the first area F1 and the second area S1. For example, the abstraction unit 246 abstracts an image area other than the specific area by reducing the resolution, converting a plurality of pixels to the same pixel value, or uniformly converting the pixels to specific pixel values. In a case where a plurality of pixels is converted into the same pixel value, the abstraction unit 246 may convert the pixel values of the plurality of pixels into an average pixel value of the plurality of pixels, or convert the pixel values into a pixel value of an any pixel among the plurality of pixels.

In the above description, the target part is at least one of the body part of the target person except for the face, baggage possessed by the target person, and decorative articles worn by the target person. However, the target part may be a reading unit of an IC card provided in the gate 60. In this case, the image processing apparatus 20a may hold a predetermined position and size within the captured image as the position and size of the reading unit of the IC card in the target part information 203.

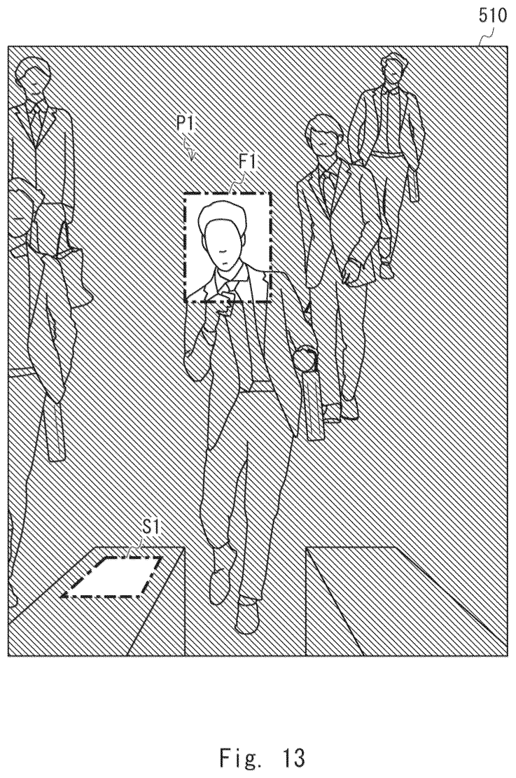

The specific example of the image processing in this case will be described with reference to FIG. 13. First, the area specification unit 245 specifies the first area F1 as in FIG. 12. In addition, the area specification unit 245 reads out the feature information of the reading unit stored in the target part information 203 and identifies a relative position and a size of the reading unit within the captured image. Then, the area specification unit 245 detects the second area S1 from the captured image based on the relative position and the size.

Furthermore, the image processing apparatus 20a may hold the information of the feature amount extracted from the image of the reading unit of the IC card in the target part information 203. In this case, the area specification unit 245 may detect, as the second area S1, an image area in which the matching degree of the feature amounts is equal to or more than a predetermined value.

Then, the abstraction unit 246 performs abstraction processing on an image area except for the first area F1 and the second area S1.

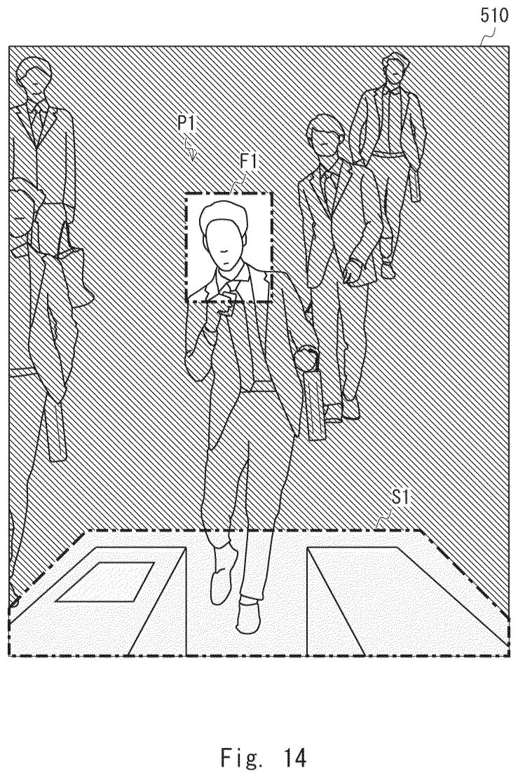

In addition, the target part may be a predetermined area near the gate 60. FIG. 14 is a view for describing the specific example of image processing according to the second example embodiment. Also in this case, the area specification unit 245 may specify the second area S1 by using the feature information registered in advance by a method similar to the case where the target part is the reading unit.

According to the second example embodiment as described above, the face area of the target person and the image area of the target part designated by the user of the image processing apparatus 20 are set as unhidden areas, and the abstraction processing is performed on the other image areas. Therefore, it is possible to flexibly set a hidden area or an unhidden area according to the verified target or depending on the operation. Accordingly, the image processing apparatus 20a may be widely used regardless of the authentication method of the authentication apparatus 10.

Furthermore, the authentication apparatus 10 may transmit the detected results of the face area and results of face authentication to the image processing apparatus 20a. Accordingly, since the detected results of the face area and results of face authentication may be diverted to the image processing, the image processing apparatus 20a may omit the face area detection processing and the face authentication processing (S62 to S63 in FIG. 10).

Furthermore, the present disclosure is not limited to the above-described example embodiments and may be appropriately changed without departing from the scope.

### First Modified Example

For example, there may be two or more types of designated target parts. As an example, the user may designate the baggage of the target person and the reading unit of the IC card as target parts. In this case, the area specification unit 245 may specify the image area of each designated target part as the second area.

### Second Modified Example

In the second example embodiment, the area specification unit 245 uniformly sets the first area and the second area as the specific area, but the specific area may be limited by the capturing time. For example, the area specification unit 245 may specify the first area and the second area within a predetermined period with respect to the time at which the target person is estimated to enter the gate 60 or the time at which the target person is estimated to exit as the specific area. At this time, the area specification unit 245 may estimate the entrance time or the exit time based on the timing of arrival of the IC card of the target person. As an example, the area specification unit 245 may estimate a predetermined time (for example, 5 seconds) before the time at which the reading unit of the IC card detects the signal as the entrance time. In addition, area specification unit 245 may estimate, as the exit time, a predetermined time (for example, two seconds) after the time at which the reading unit detects the signal. Then, the area specification unit 245 may specify, as the specific area, the first area and the second area of the captured image obtained by capturing from the entrance time to the exit time, and exclude, from the specific area, the first area and the second area of otherwise captured images. Accordingly, since information unnecessary for verification is hidden, verification of the authentication results may be suitably performed. In particular, in a case where face authentication is the walk-through method, the operation of entering and exiting the gate 60 may be suitably verified.

### Third Modified Example

In the above-described example embodiments, the authentication apparatus 10 performs personal authentication on the authenticated target person by face authentication. However, the personal authentication may be multi-factor authentication including first authentication that is face authentication and second authentication other than the face authentication. For example, the second authentication may be authentication for determining whether the target person is taking a pose registered in advance when passing the gate. Alternatively, the second authentication may be authentication for determining whether the target person directs his/her line of sight toward a direction registered in advance when passing the gate. Alternatively, the second authentication may be authentication for determining whether the user possesses baggage registered in advance or wears decorative articles registered in advance. Alternatively, the second authentication may be authentication by reading an IC card. The part used for the second authentication is the target part.

In this case, the authentication apparatus 10 may store target part information that stores the type of the target part and the feature information of the target part. The authentication apparatus 10 may perform the second authentication on the image area of the target part by using the target part information, in addition to the first authentication which is the face authentication. Then, in a case where the first authentication has succeeded and the second authentication has succeeded, the authentication apparatus 10 transmits the fact that the personal authentication has succeeded, to the authentication terminal 40. On the other hand, in a case where any authentication has failed, the authentication apparatus 10 transmits the fact that the personal authentication has failed, to the authentication terminal 40.

For example, details of the personal authentication are as follows. First, the detection unit 143 of the authentication apparatus 10 detects, from the captured image, the second area used for the second authentication in addition to the face area. Next, the authentication unit 144 of the authentication apparatus extracts a feature amount from the second area detected by the detection unit 143 and sets the feature amount as the feature information for use of authentication. Then, the authentication unit 144 collates the feature information for use of authentication with the feature information associated with 10 the target person ID in the target part information 103. The authentication unit 144 performs face authentication on the person depending on the results of the first authentication based on the face information and the results of the second authentication based on the feature information for use of authentication extracted from the second area.

In a case where the authentication apparatus 10 adopts the multi-factor authentication as described above, the setting unit 242 of the image processing apparatus 20a may set, as the target part, a part corresponding to the authentication method of the authentication apparatus 10. For example, the setting unit 242 of the image processing apparatus 20a may receive the authentication method from the authentication apparatus 10 and set, as the designated target part, a part corresponding to the authentication method. Accordingly, the user input may be omitted. In addition, for example, the setting unit 242 of the image processing apparatus 20a may receive, from the user, the designation of the method of the second authentication, and set, as the designated target part, a part corresponding to the received method. Accordingly, it is possible to flexibly set a hidden area or an unhidden area in conjunction with the authentication method of the authentication apparatus 10. Therefore, user input is simplified.

Furthermore, a mode such as the presence or absence of the second authentication or the authentication method of the second authentication may be set for each gate 60. For example, one-factor authentication by face authentication may be set in the first gate, and two-factor authentication of face authentication and IC card authentication may be set in the second gate. In this case, the setting unit 242 may set whether or not to set the target part and where to set the target part according to the mode set for each gate 60. In the above-described example, the setting unit 242 may not set the target part for the captured image obtained by capturing at the first gate. That is, the abstraction unit 246 does not need to perform abstraction processing on the captured image obtained by capturing at the first gate. In addition, the setting unit 242 may set, as the target part, the reading unit for the captured image obtained by capturing at the second gate. That is, the abstraction unit 246 may perform abstraction processing on an image area excluding the face of the target person and the reading unit of the captured image obtained by capturing at the second gate.

### OTHER MODIFIED EXAMPLES

In the described-above second example embodiment, the image processing apparatus 20a receives the captured image from the authentication apparatus 10, but may receive the captured image from the authentication terminal 40. In addition, although the image processing apparatus 20a performs image processing on the captured image used for the face authentication by the authentication apparatus 10, the image processing apparatus 20a may similarly perform image processing on the other captured images than the captured image used for the face authentication by the authentication apparatus 10.

In addition, in the described-above second example embodiment, the authentication apparatus 10 and image processing apparatus 20a are separate apparatus, but the authentication apparatus 10 and image processing apparatus 20a may be configured as the same apparatus.

The present disclosure may also be implemented by causing a processor to execute a computer program in order to perform any processing.

In the above-described example, the program includes a group of instructions (or software code) for causing a computer to perform one or more functions described in the example embodiments when the program is read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or communication medium. As an example and not by way of limitation, the transitory computer-readable medium or communication medium includes electrical, optical, acoustic, or other forms of propagated signals.

Some or all of the above-described example embodiments may be described as in the following Supplementary Notes, but are not limited to the following Supplementary Notes.

### Supplementary Note 1

An image processing apparatus comprising:
a setting means for setting a designated part other than a face of a target person as a target part;
an authentication means for determining whether or not a predetermined target person is included in a captured image obtained by capturing an area within a predetermined range with respect to a gate;
an area specification means for specifying a first area that is a face area of the target person and a second area that is an image area of the target part as a specific area not to be subjected to abstraction processing in a case where the target person is included in the captured image; and
an abstraction means for performing abstraction processing on an image area except for the specified specific area.

### Supplementary Note 2

The image processing apparatus according to Supplementary Note 1, wherein the target part includes at least one of a body part of the target person except for the face, baggage possessed by the target person, and decorative articles worn by the target person.

### Supplementary Note 3

The image processing apparatus according to Supplementary Note 2, wherein the area specification means detects the second area based on the specified position of the face area of the target person and a type of the target part.

### Supplementary Note 4

The image processing apparatus according to Supplementary Note 1 or 2, wherein the target part includes a reading unit installed at the gate.

### Supplementary Note 5

The image processing apparatus according to any one of Supplementary Note 1 to 4, wherein the area specification means specifies, as the specific area, the first area and the second area within a predetermined period with respect to a time at which the target person is estimated to enter the gate or a time at which the target person is estimated to exit.

### Supplementary Note 6

An authentication system comprising:
an authentication apparatus that performs face authentication based on a face area of a person; and
an image processing apparatus, wherein
the image processing apparatus includes
a setting means for setting a designated part other than a face of a target person as a target part,
an authentication means for determining whether or not a predetermined target person is included in a captured image obtained by capturing an area within a predetermined range with respect to a gate,
an area specification means for specifying a first area that is a face area of the target person and a second area that is an image area of the target part as a specific area not to be subjected to abstraction processing in a case where the target person is included in the captured image, and
an abstraction means for performing abstraction processing on an image area except for the specified specific area.

### Supplementary Note 7

The authentication system according to Supplementary Note 6, wherein
the authentication apparatus performs
detecting the second area from the captured image, and
performing authentication on the person further based on the results of face authentication and the results of a second authentication based on a feature amount extracted from the second area.

### Supplementary Note 8

The authentication system according to Supplementary Note 7, wherein the setting means sets, as the target part, a part corresponding to the method of the second authentication.

### Supplementary Note 9

An image processing method comprising:
setting a designated part other than a face of a target person as a target part;
determining whether or not a predetermined target person is included in a captured image obtained by capturing an area within a predetermined range with respect to a gate;
specifying a first area that is a face area of the target person and a second area that is an image area of the target part as a specific area not to be subjected to abstraction processing in a case where the target person is included in the captured image; and
performing abstraction processing on an image area except for the specified specific area.

### Supplementary Note 10

A non-transitory computer-readable medium storing a program for causing a computer to implement:
a function of setting a designated part other than a face of a target person as a target part;
a function of determining whether or not a predetermined target person is included in a captured image obtained by capturing an area within a predetermined range with respect to a gate;
a function of specifying a first area that is a face area of the target person and a second area that is an image area of the target part as a specific area not to be subjected to abstraction processing in a case where the target person is included in the captured image; and
a function of performing abstraction processing on an image area except for the specified specific area.

### REFERENCE SIGNS LIST

1 AUTHENTICATION SYSTEM
10 AUTHENTICATION APPARATUS
20, 20a IMAGE PROCESSING APPARATUS
22 SETTING UNIT
23 DETECTION UNIT
24 AUTHENTICATION UNIT
25 AREA SPECIFICATION UNIT
26 ABSTRACTION UNIT
30 IMAGE STORAGE APPARATUS
40 AUTHENTICATION TERMINAL
60 GATE
61 FIRST GATE BODY
62 SECOND GATE BODY
63 FLAP
64 READING UNIT
100 STORAGE UNIT
10 PROGRAM
102 FACE INFORMATION DB
110 MEMORY
120 COMMUNICATION UNIT
140 CONTROL UNIT
141 REGISTRATION UNIT
143 DETECTION UNIT
144 AUTHENTICATION UNIT
200 STORAGE UNIT
201 PROGRAM
202 FACE INFORMATION DB
203 TARGET PART INFORMATION
210 MEMORY
220 COMMUNICATION UNIT
230 INPUT UNIT
240 CONTROL UNIT
241 REGISTRATION UNIT
242 SETTING UNIT
243 DETECTION UNIT
244 AUTHENTICATION UNIT
245 AREA SPECIFICATION UNIT
246 ABSTRACTION UNIT
250 DISPLAY UNIT
410 CAMERA
420 STORAGE UNIT
430 COMMUNICATION UNIT
440 DISPLAY UNIT
450 INPUT UNIT
460 CONTROL UNIT
500 CAPTURED IMAGE
510 ABSTRACTED IMAGE
600 INPUT IMAGE

What is claimed is:

1. An image processing apparatus comprising:
at least one memory storing instructions, and
at least one processor configured to execute the instructions to;
set a designated part other than a face of a target person as a target part;
determine whether or not a predetermined target person is included in a captured image obtained by capturing an area within a predetermined range with respect to a gate;
specify a first area that is a face area of the target person and a second area that is an image area of the target part as a specific area not to be subjected to abstraction processing in a case where the target person is included in the captured image; and
perform abstraction processing on an image area except for the specified specific area.

2. The image processing apparatus according to claim 1, wherein the target part includes at least one of a body part of the target person except for the face, baggage possessed by the target person, and decorative articles worn by the target person.

3. The image processing apparatus according to claim 2, wherein at least one processor configured to execute the instructions to detect the second area based on a specified position of the face area of the target person and a type of the target part.

4. The image processing apparatus according to claim 1, wherein the target part includes a reading unit installed at the gate.

5. The image processing apparatus according to claim 1, wherein at least one processor configured to execute the instructions to specify, as a specific area, the first area and the second area within a predetermined period with respect to a time at which the target person is estimated to enter the gate or a time at which the target person is estimated to exit.

6-8. (canceled)

9. An image processing method comprising:
setting a designated part other than a face of a target person as a target part;
determining whether or not a predetermined target person is included in a captured image obtained by capturing an area within a predetermined range with respect to a gate;
specifying a first area that is a face area of the target person and a second area that is an image area of the target part as a specific area not to be subjected to abstraction processing in a case where the target person is included in the captured image; and
performing abstraction processing on an image area except for the specified specific area.

10. A non-transitory computer-readable medium storing a program for causing a computer to implement:
a function of setting a designated part other than a face of a target person as a target part;
a function of determining whether or not a predetermined target person is included in a captured image obtained by capturing an area within a predetermined range with respect to a gate;
a function of specifying a first area that is a face area of the target person and a second area that is an image area of the target part as a specific area not to be subjected to abstraction processing in a case where the target person is included in the captured image; and
a function of performing abstraction processing on an image area except for the specified specific area.

11. A non-transitory computer-readable medium according to claim 10, wherein the target part includes at least one of a body part of the target person except for the face, baggage possessed by the target person, and decorative articles worn by the target person.

12. A non-transitory computer-readable medium according to claim 10, wherein the program causes the computer to implement:
a function of detecting the second area based on a specified position of the face area of the target person and a type of the target part.

13. A non-transitory computer-readable medium according to claim 10, wherein the target part includes a reading unit installed at the gate.

14. A non-transitory computer-readable medium according to claim 10, wherein the program causes the computer to implement:
a function of specifying, as a specific area, the first area and the second area within a predetermined period with respect to a time at which the target person is estimated to enter the gate or a time at which the target person is estimated to exit.
